(19) United States
(12) Patent Application Publication
(10) Pub. No.: US 2012/0182315 A1
(43) Pub. Date: Jul. 19, 2012

(54) Make a Face

(76) Inventor: Kenneth Alan Garzo, Campbell, CA (US)

(21) Appl. No.: 13/161,457

(22) Filed: Jun. 15, 2011

Related U.S. Application Data
(60) Provisional application No. 61/461,331, filed on Jan. 18, 2011.

(51) Int. Cl. G09G 5/00

(52) U.S. Cl. 345/635

(57) ABSTRACT

This invention relates to the field of computer graphics, specifically, Make a Face is software to divide photographic images of human faces into quadrants whose common point is the center tip of the nose. These quadrants are then merged to form a cohesive facial image from multiple facial graphic sources.

### BACKGROUND OF THE INVENTION

### Description of the Related Art

The software application does not relate to, or rely upon, previously presented software applications whose purpose is to morph one face into another face. In those applications the process is intended to create a video display of one face changing into another face, such that the face which is displayed at the start of the process is changed along points of distortion until it becomes the target face. Neither does Make a Face relate to, or rely upon, previously presented software applications whose purpose is to create a larger image from a mosaic of many smaller images using the colors and shades of the individual smaller images. Nor does Make a Face apply a process of facial distortion or image enhancement to the subject graphics. Also, the many differing computer codes that can effect the process of delineation of a graphic into scalable quadrants has existed in the public domain for many years and is not within the claim of this non-provisional patent application.

Although such computer software applications as referenced above have achieved considerable popularity and commercial success, there exists a compelling need for novel approaches to the use of computer application graphics software to process diverse facial characteristics for primarily elucidative purposes, with the aim of uniting the different perspectives of mankind to its common heritage.

### SUMMARY OF THE INVENTION

The Make a Face application processes graphics of facial components from up to four different faces at a time, drawn from an infinite number of face graphics, in a manner which does not distort them, but which subdivides them and then merges them together to form a graphic of a face in which the component facial characteristics of the differing faces are recognizable both individually and as a compiled graphic forming the image of a new face.

The new face that is formed illuminates the distinctly differing and distinctly similar characteristics of the facial components that contribute to the merged Make a Face graphic.

### DETAILED DESCRIPTION OF THE INVENTION

The central key to the process by which the Make a Face application operates relates to the physiological coordinates which define the facial characteristics of human beings of all different ethic backgrounds: the facial features ratio.
If we define the distance from the very top of the head to the very bottom of the chin as X, then in virtually all human faces, the distance from the top of the human head to the center tip of the nose is within two points of 70% of X and the distance from the center tip of the nose to the bottom of the chin is within two points of 30% of X. See FIG. 4.

The software application provides the means by which a photograph of a human face encompassing the area from the top of the head to the bottom of the chin, and from the widest part of one ear to the widest part of the other ear may be divided into quadrants, whose common point is the center tip of the nose. See FIG. 3.

Each quadrant is then separately stored by the program, and can then be summoned to form the graphic of a face comprised of any combination of the stored quadrants. The quadrant graphics are entered into four separate scalable fields so that any dissimilar sizes that exist in the photographs of the component faces are proportionately sized and combined to form an undistorted facial image that merges smoothly with the images in each of the other quadrants. This compendium image of the many different and similar facial characteristics of human beings brings unique focus to the structural and expressive elements of the primary facial components of the eyes, the nose, the chin, the cheeks, the lips, the ears, the forehead, and skull shapes. These elements are referenced in FIGS. 1 through 8.

It is both the juxtaposition of incongruous expressive and physiological facial characteristics, as well as the juxtaposition of similar expressive and physiological facial characteristics which, when separated into quadrants and then recombined, draw elucidative focus to the shared yet diverse physiological and expressive elements of all mankind. The blended faces will be symmetrical and align themselves almost perfectly, yielding a novel physiological study of different facial characteristics, both of people related to each other, as well as people of very different ethnic backgrounds. See FIG. 1.

Dividing a full face picture of any individual into quadrants implementing the 70/30 facial features ratio whose common point is the center tip of the nose also serves the purpose of facilitating the process of facial recognition software to identify faces lacking idiosyncratic or anomalous features by focusing on the specific elements of a facial quadrant, instead of the entire face (which may supply too much data to be successfully associated), or a smaller individual feature such as an eye, mouth, or nose (which may supply too little data to be successfully associated).

It is also possible, of course, to create any number of weird, peculiar, funny, and dysmorphic effects by dividing the facial graphic into lopsided quadrants whose common point is not the center tip of the nose, but this is not the intended utility of the Make a Face facial features ratio implementation.

Activating the “Make a Face” button will start an automatic, random selection combining sequence of the imported facial graphic quadrants. A click will stop it. Clicking the popup menus at the corners permits the user to choose the specific face quadrants that he or she may wish to display.

### DESCRIPTION OF THE DRAWINGS

In the drawings, which form a part of this specification, all the shown lines of division occur at the “facial features ratio” dividing line: precisely 70% down from the top of the head to the center tip of the nose, precisely 30% up from the chin to the center tip of the nose, and equidistant from the outside edges of the earlobes.

FIG. 1 is a representation of a Make a Face display of a merged graphic comprised of separate quadrants from four distinctly different individuals using the facial features ratio.

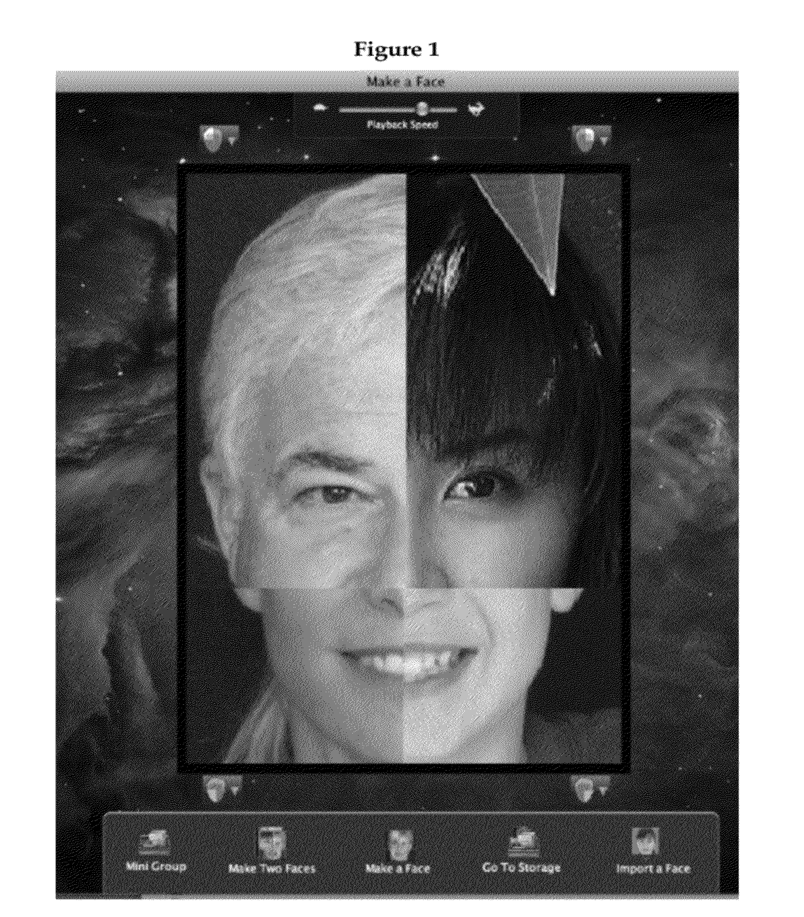

FIG. 2 is a graphic of a 5 year old male child whose lower left facial quadrant is included in FIG. 1.

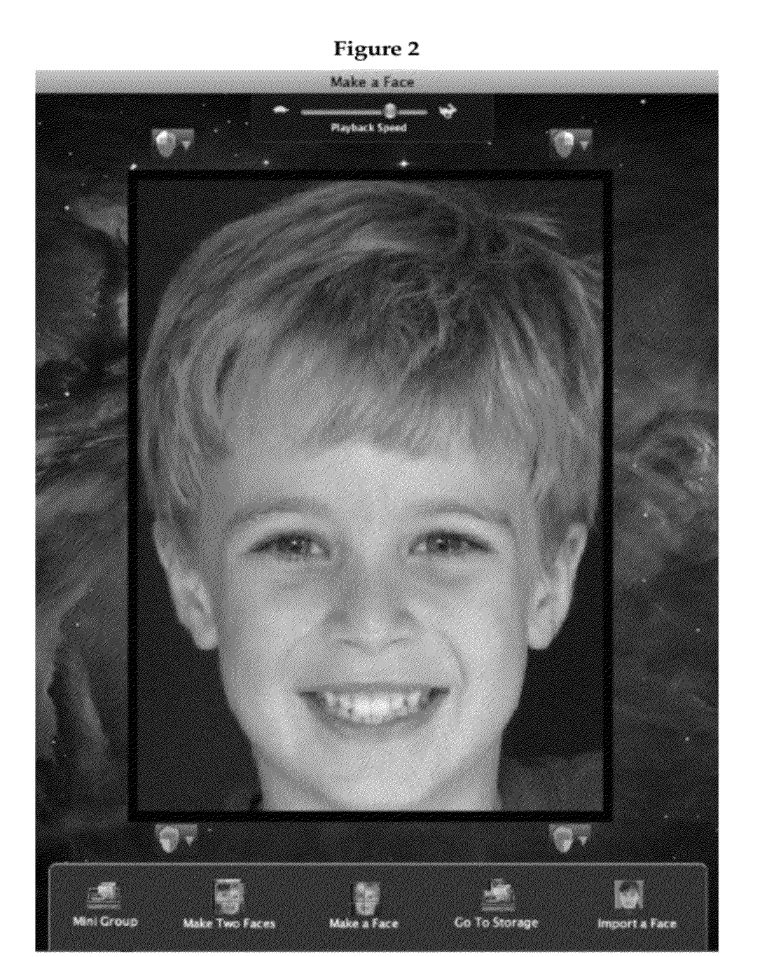

FIG. 3 is an exploded representation of the FIG. 2 graphic, divided into quadrants with the common point being the center tip of the nose using the facial features ratio.

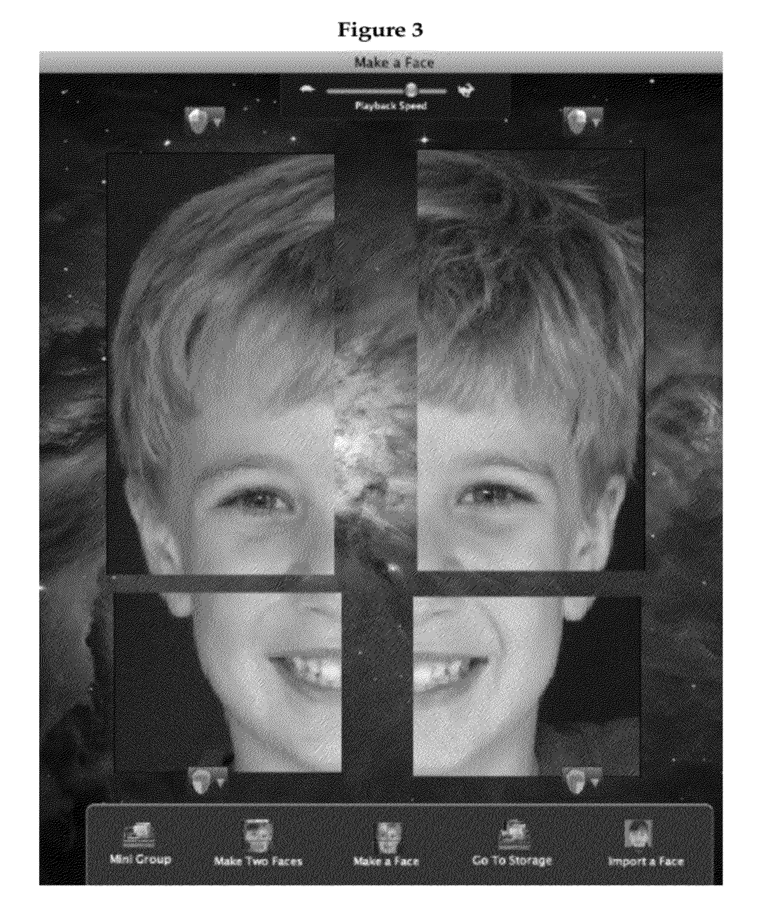

FIG. 4 is a graphic of the 5 year old male child showing the quadrant division delineations. The lower left quadrant of this graphic is included in the FIG. 1 graphic.

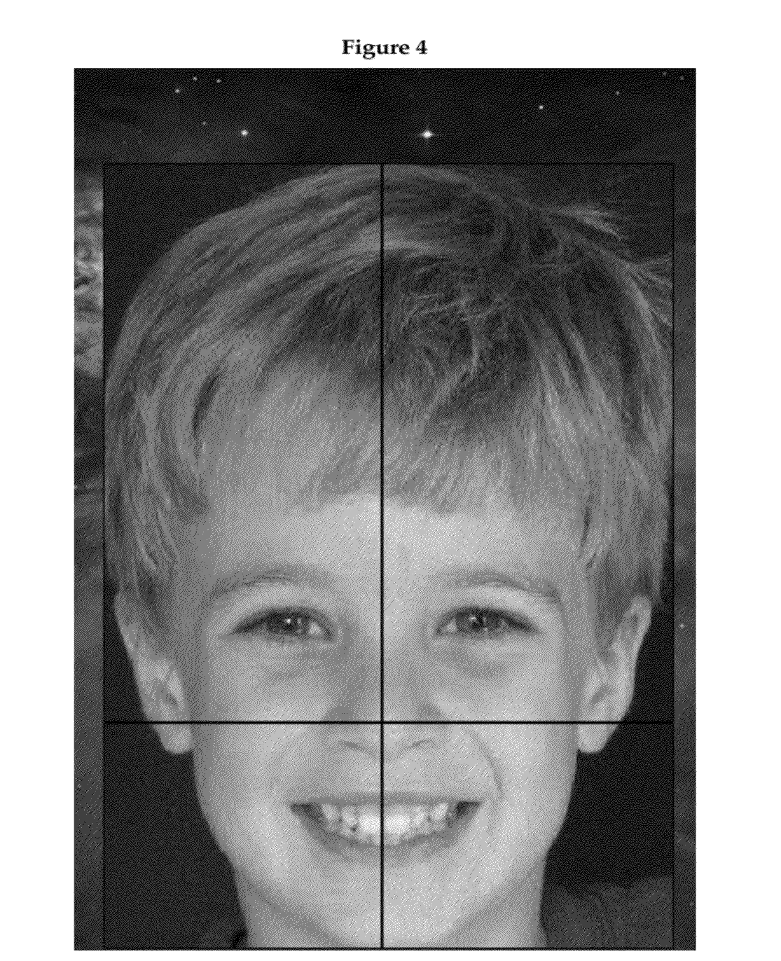

FIG. 5 is a graphic of an adult male whose upper right quadrant is included in the FIG. 1 graphic.

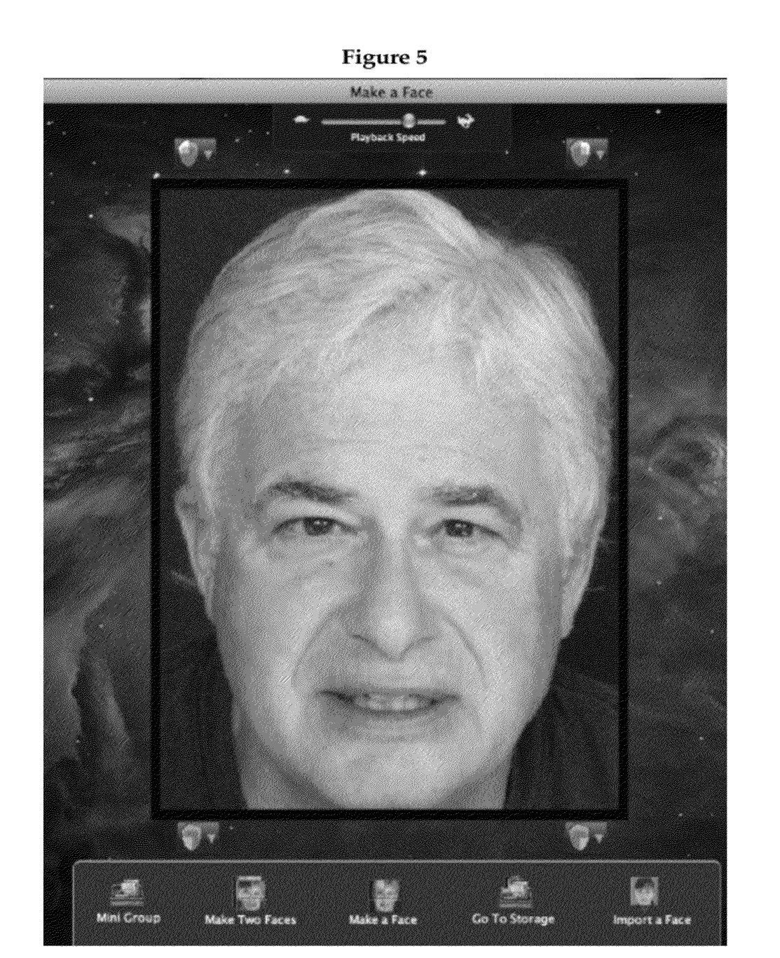

FIG. 6 is of an adult female whose lower right quadrant is included in the FIG. 1 graphic.

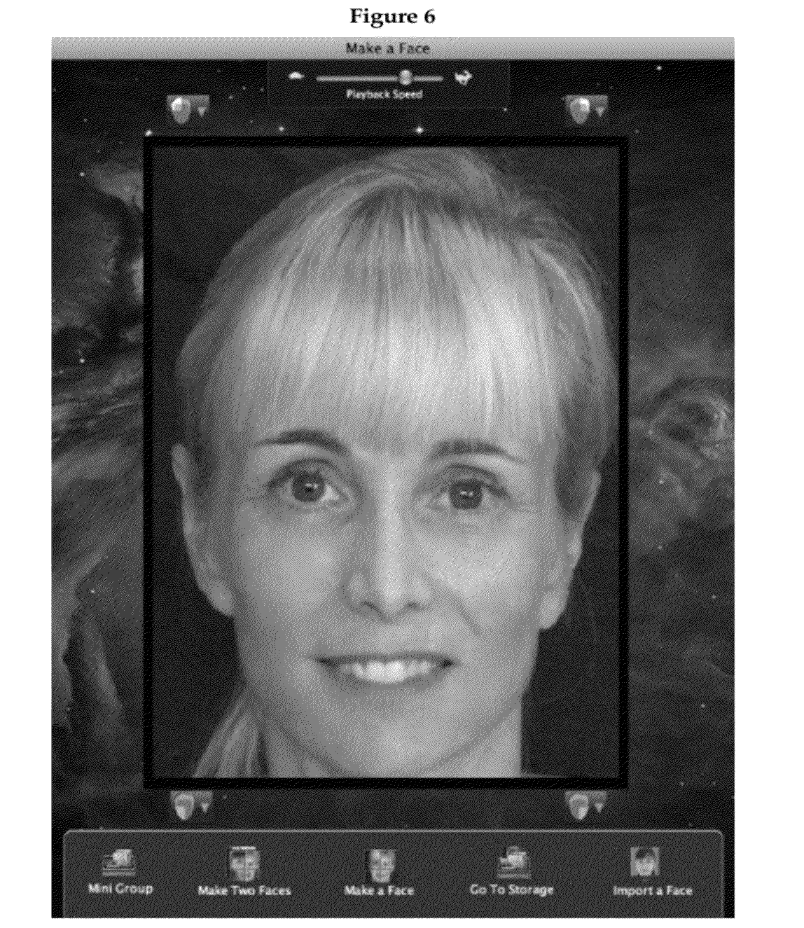

FIG. 7 is an exploded representation of the FIG. 1 graphic, divided into quadrants with the common point being the center tip of the nose using the facial features ratio.

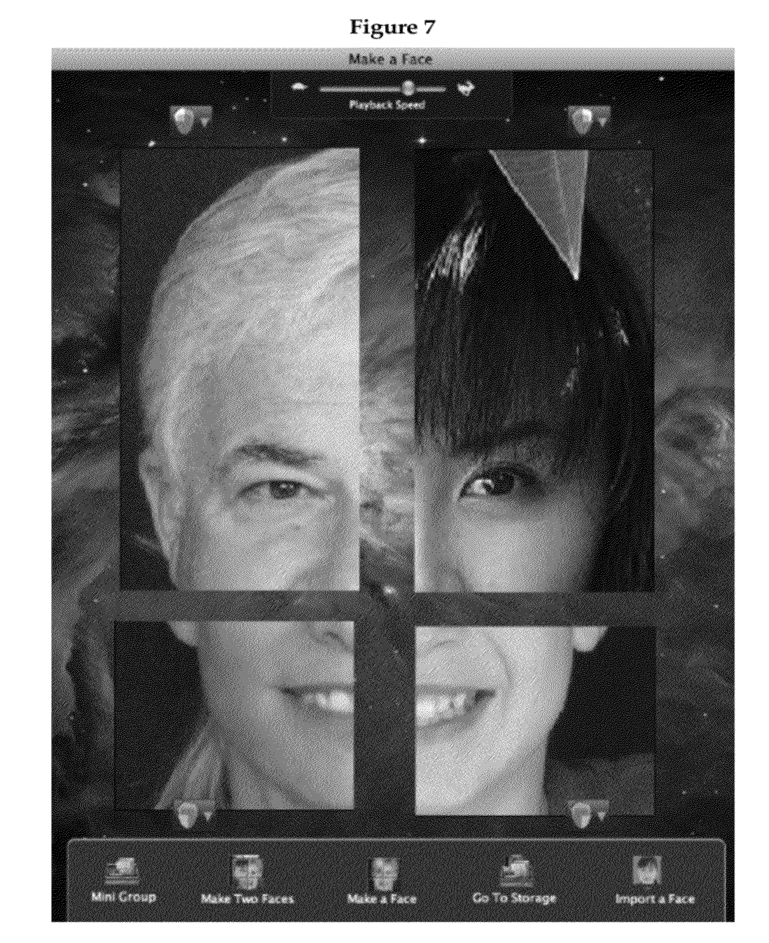

FIG. 8 is a graphic of a young adult female whose upper left quadrant is included in the FIG. 1 graphic.

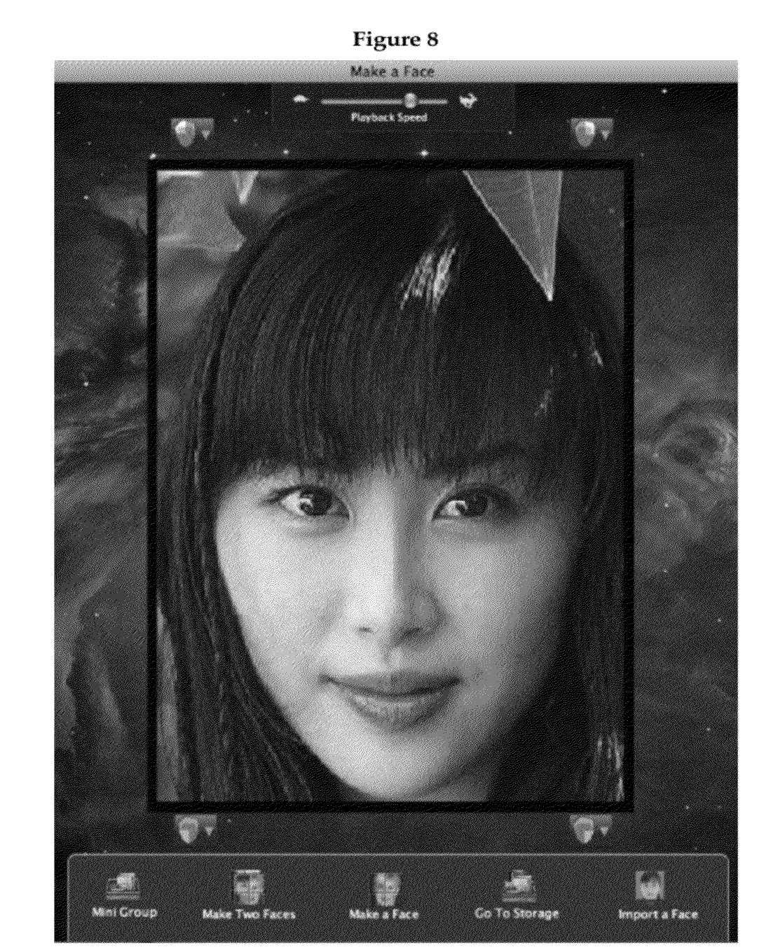

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the stated claims. Although specific terms are employed herein, they are used in a generic and descriptive sense only and not for purposes of limitation.

The embodiments of the invention in which an exclusive property or privilege is claimed are defined as follows:

1. The process by which Make a Face operates is an entirely novel approach to the display of human facial characteristics in juxtaposition for the purposes of elucidation, entertainment, and the study of physiological differences and similarities.
The software process at work in Make a Face is to present and combine delineated, undistorted, and juxtaposed quadrants of facial pictures, whose common point is the center tip of the nose. The graphic thus created implements the 70/30 facial features ratio described in the application and is uniquely able to focus attention on the physiological facial characteristics which both unite and differentiate mankind, defining us as individuals with distinct, diverse, and compounded ethnic characteristics that ultimately reflect unequivocally mutual elements.
